(19) United States
(12) Patent Application Publication
(10) Pub. No.: US 2009/0201204 A1
(43) Pub. Date: Aug. 13, 2009

(54) Modal beam positioning

(75) Inventors: Donald N. Black, JR., Cumming, GA (US); Enrique Jesus Ruiz, Duluth, GA (US); Theresa Brunasso, Snellville, GA (US); Catherine L. Freeman, Norcross, GA (US); William M. Smith, Duluth, GA (US); John Haslam, Alpharetta, GA (US); John L. Beafore, Duluth, GA (US)

Correspondence Address: KING & SPALDING, 1180 PEACHTREE STREET , NE, ATLANTA, GA, 30309-3521, US

(73) Assignee: EMS Technologies, Inc.

(21) Appl. No.: 12/322,592

(22) Filed: Feb. 4, 2009

Related U.S. Application Data
(60) Provisional application No. 61/063,642, filed on Feb. 5, 2008.

(51) Int. Cl. H01Q 3/00; H01Q 19/10; H01Q 21/08

(52) U.S. Cl. 342/372; 343/755; 343/824

(57) ABSTRACT

An antenna system with an improved antenna feed system is discussed. This multi-beam antenna system can produce a beam of electromagnetic energy propagating in a desired direction by emitting multiple beams of electromagnetic energy that constructively and destructively interfere. The direction of the net beam of electromagnetic energy can be controlled by adjusting the phase and amplitude of the emitted beams of electromagnetic energy which in turn influences the constructive and destructive interference. The phase and amplitude adjustments can be determined by sampling coordinate rotation or similar functions. Aliased components of these functions can be particularly useful in element reduction.

### RELATED APPLICATIONS

This patent application claims priority under 35 U.S.C. §119 to U.S. Provisional Patent Application No. 61/063,642, entitled “Modal Beam Positioning,” filed Feb. 5, 2008. The entire contents of the above-identified priority application is hereby fully incorporated herein by reference.

### FIELD OF THE TECHNOLOGY

The present invention relates to antennas and more specifically to an antenna system with multiple antenna feed elements emitting beams of electromagnetic radiation that constructively and destructively interfere to result in a net beam of electromagnetic radiation.

### BACKGROUND

A multi-beam antenna system is generally an antenna system having multiple antenna feed elements, each pointing in a different direction and at a different angle. The multiple antenna feed elements allow for the multi-beam antenna system to access (transmit and receive) other antennas and/or satellites that are not at a fixed location with respect to the multi-beam antenna system. Each antenna feed element can be directed to a different antenna or satellite for access to each using the one multi-beam antenna.

Conventional multi-beam antenna systems generally need a separate antenna feed element for each direction that the multi-beam antenna system is intended to send or receive a signal. For a multi-beam antenna system that communicates in many directions, the size of the feed system can limit the ability to scale down the size of the multi-beam antenna system. It can also limit the ability to increase the size of the lens of the multi-beam antenna system as more antenna feed elements would typically be employed with a larger lens. The large number of antenna feed elements can also increase the manufacturing costs associated with the multi-beam antenna system.

Accordingly, there is a need in the art for a multi-beam antenna comprising a feed system with fewer antenna feed elements but capable of communicating in many directions. A further need exists for an antenna that provides improved beam steering.

### SUMMARY

The present invention can support an antenna system capable of generating a net beam of electromagnetic energy propagating in a desired direction by emitting multiple beams of electromagnetic energy that constructively and destructively interfere. The direction of the net beam of electromagnetic energy can be controlled by adjusting the phase and amplitude of the emitted beams of electromagnetic energy which in turn influences the constructive and destructive interference.

In one aspect of the present invention, a method for emitting electromagnetic radiation can include emitting a first beam of electromagnetic radiation from a first antenna feed element aimed in a first direction; emitting a second beam of electromagnetic radiation in a second direction; and providing a third beam of electromagnetic radiation propagating in a third different direction in response to adjusting phase and amplitude of each of the first and second beams of electromagnetic radiations.

The discussion of multi-beam antennas presented in this summary is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are to be included within this description, are to be within the scope of the present invention, and are to be protected by the accompanying claims.

### BRIEF DESCRIPTION OF THE DRAWINGS

FIG. 1 illustrates a multi-beam antenna system according to certain exemplary embodiments of the present invention.

FIG. 2 illustrates a multi-beam antenna system including an array of feeds for emitting a beam of electromagnetic radiation according to certain exemplary embodiments of the present invention.

FIG. 3 illustrates a flow diagram of a method for initializing a multi-beam antenna system according to certain exemplary embodiments of the present invention.

FIG. 4 illustrates a flow diagram of a method for emitting a beam of electromagnetic radiation from a multi-beam antenna system according to certain exemplary embodiments of the present invention.

Many aspects of the invention can be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views.

### DETAILED DESCRIPTION OF EXEMPLARY EMBODIMENTS

The present invention can support the design and operation of a multi-beam antenna with a reduced number of feeds, improved directional ability, and multiple frequencies of operation.

Multiple antenna feed elements, each aimed in a different direction, can emit a beam of electromagnetic energy. Each emitted beam of electromagnetic energy can constructively and destructively interfere to produce a net beam of electromagnetic energy propagating in a desired direction. This constructive and destructive interference can be controlled by adjusting the phase and amplitude of each emitted beam of electromagnetic energy.

While the multi-beam antenna system may be referred to as specifically radiating or receiving, one of ordinary skill in the art will appreciate that various embodiments are widely applicable to both transmitting (exciting a medium) and receiving (be excited by a medium) without departure from the spirit or scope of the invention. Any discussions focusing on a single direction or sense of operation should be considered non-limiting examples. Those of ordinary skill in the art having benefit of this disclosure will appreciate that exemplary antennas can transmit bidirectionally or in either direction in accordance with principles of electromagnetic reciprocity. Accordingly, the exemplary multi-beam antenna described below may both receive and transmit electromagnetic energy in support of communications applications or in electronic countermeasures.

Certain embodiments of the present invention can comprise a computer program that embodies some of the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention.

The invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting, and among others supported by representations of the present invention.

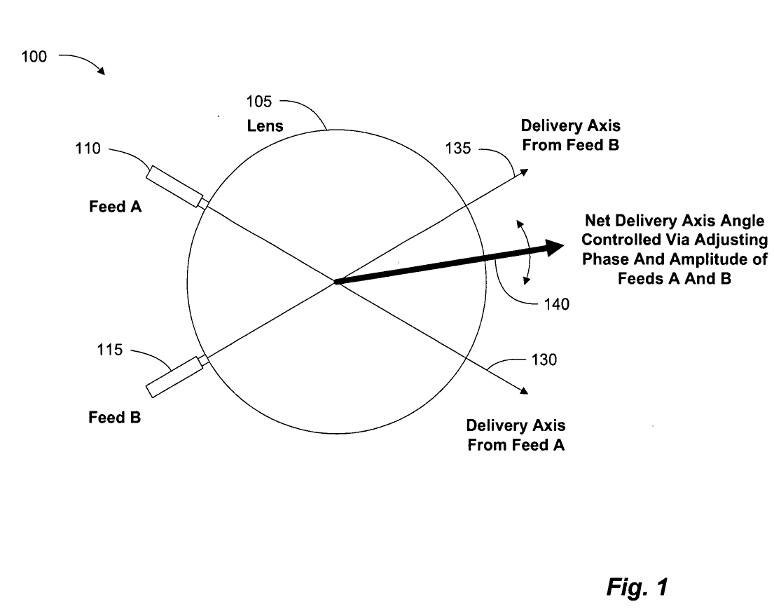

Turning now to FIG. 1, the figure illustrates a multi-beam antenna system 100 according to certain exemplary embodiments of the present invention. The multi-beam antenna system 100 comprises an electromagnetic lens 105 and two antenna feed elements 100, 115.

The electromagnetic lens 105 of the multi-beam antenna system 100 can comprise various designs, geometries, and materials. For example, the electromagnetic lens 105 can comprise a spherical lens, hemispherical lens, a partially spherical lens, a cylindrical lens, a layered gradient lens, a continuous gradient lens, an inverted (negative index) gradient lens, a Rotman lens, a constant-K lens, or a Luneburg lens. The lens materials can include but is not limited to polycarbonate, Rexolite, and other plastics. The multi-beam antenna system 100 can also comprise more than one electromagnetic lens 105. For example, a second electromagnetic lens can be used to correct aberrations created by a first electromagnetic lens. Various other lens designs can also be used with the multi-beam antenna system 100, as will be known to one of ordinary skill in the art having the benefit of the present disclosure. Moreover, the multi-beam antenna system 100 can comprise a shaped reflector in place of the electromagnetic lens 105 or functioning in collaboration with the electromagnetic lens 105.

The first antenna feed element, “Feed A” 110 and the second antenna feed element, “Feed B” 115 can be installed at or near the electromagnetic lens 105 in fixed positions relative to one another and with a fixed angle between the respective delivery axes. Feed A 110 radiates a beam of electromagnetic energy into the electromagnetic lens 105 along delivery axis 130. Feed B 115 radiates another beam of electromagnetic energy into the lens 105 along another delivery axis 135. Feed A 110 and Feed B 115 can each comprise a waveguide for directing the beams of electromagnetic energy along their respective delivery axes. Although illustrated as converging inside the electromagnetic lens 105, in many cases the delivery axes 130 and 135 will cross outside the electromagnetic lens 105. Feed A 110 and Feed B 115 can also receive beams of electromagnetic energy propagating along each antenna feed element's respective delivery axis.

Inside the electromagnetic lens 105, the beam of electromagnetic energy radiated from Feed A 110 constructively and destructively interferes with the beam of electromagnetic energy radiated from Feed B 115. Constructive interference can generally be described as a net gain in amplitude resulting from two or more beams of electromagnetic energy interacting in a specific direction. For example, if two beams of electromagnetic energy are propagating at the same frequency and are in phase for a specific direction, the resulting beam of electromagnetic energy would be the sum of the amplitudes of the two individual beams of electromagnetic energy. Similarly, destructive interference can generally be described as a net loss in amplitude resulting from two or more beams of electromagnetic energy interacting in a specific direction. An example of destructive interference is two beams of electromagnetic energy propagating at the same frequency with the same amplitude but 180° out of phase for a specific direction. In this example, the destructive interference would result in the two beams of electromagnetic energy cancelling each other. Intermediate levels of constructive and destructive interference can be achieved from multiple beams of electromagnetic energy propagating at the same or different frequencies, with varying phases and varying amplitudes.

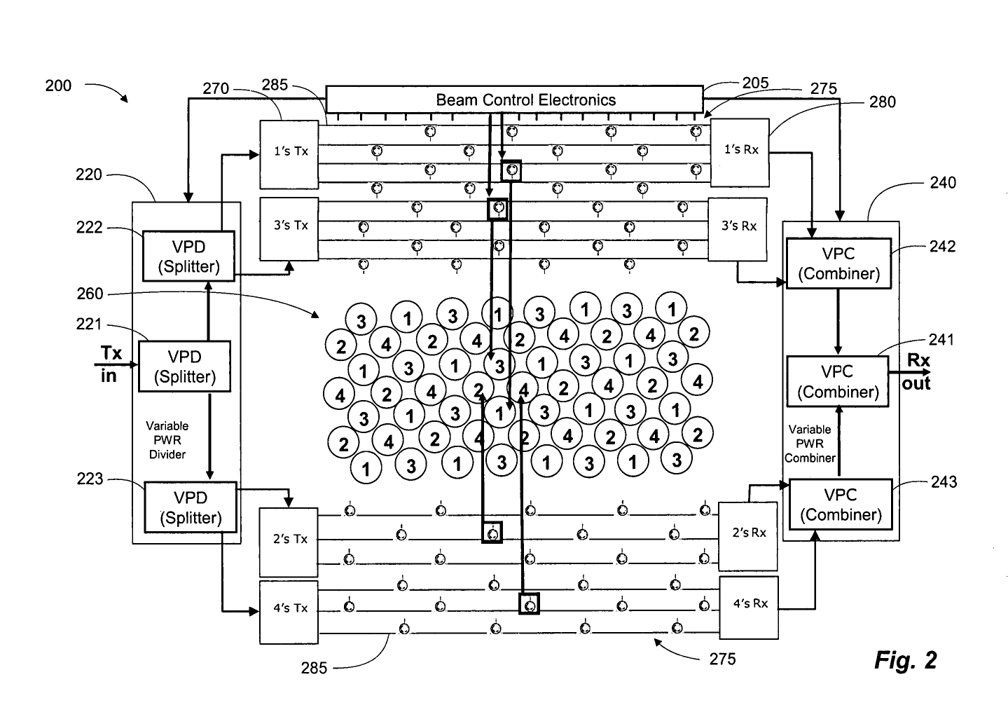

The constructive and destructive interference of the two beams of electromagnetic energy emitted from Feed A 110 and Feed B 115 can occur in a pattern that results in a third beam of electromagnetic energy propagating along a net delivery axis 140. The direction of the net delivery axis 140 is variable and can be controlled by adjusting the phase and/or amplitude of the electromagnetic radiation emitted by Feed A 110 and/or Feed B 115, which in turn influences the constructive and destructive interference. Thus, adjusting phase and amplitude of Feed A 110 and Feed B 115 steers the net delivery axis 140 of the composite beam. Although the illustration of FIG. 2 is two dimensional, the principle applies to three dimensional embodiments where the composite beam is steerable in two rotational directions for three dimensional beam steering.

The net delivery axis 140 can be directed along any axis between the delivery axis 130 of Feed A 110 and the delivery axis of Feed B 115. This variable net delivery axis 140 can replace a need for additional antenna feed elements positioned between Feed A 110 and Feed B 115. Accordingly, the multi-beam antenna system 100 can be scaled down in size. Or, the additional space around the lens can be used to position antenna feed elements operating at a different frequency and/or for a different service.

Although this multi-beam antenna system 100 comprises two feed elements 110, 115, any number of feed elements can be used. In fact, additional feed elements can support finer control of the direction of the net delivery axis 140. In some embodiments, the multi-beam antenna system 100 can comprise two pairs of feed elements. In this embodiment, a first pair of feed elements can control the direction of the net delivery axis along a first axis and a second pair of feeds can control the direction of the net delivery axis along a second axis. In other embodiments, as will be described below in more detail with reference to FIG. 2, a multi-beam antenna system can comprise an array of feeds.

Turning now to FIG. 2, the figure illustrates a multi-beam antenna system 200 according to certain exemplary embodiments of the present invention. The multi-beam antenna system 200 comprises an array of antenna feed elements (hereinafter “feed array”) 260. Each antenna feed elements of the feed array can be instances of Feed A 110 or Feed B 115 and can be adapted to radiate and/or receive a beam of electromagnetic energy through an electromagnetic lens 105 (See FIG. 1). The electromagnetic lens 105 can comprise various lens designs as described above with reference to FIG. 1.

The feed array 260 can comprise one or more networks of antenna feed elements arranged at or near the electromagnetic lens. In the illustrated embodiment, the feed array 260 comprises four networks, or banks, labeled 1, 2, 3, and 4 in the feed array 260. Each antenna feed element of the feed array 260 can be arranged to transmit and receive electromagnetic energy in a different direction and at a different angle with respect to the other antenna feed elements of the feed array 260.

In this embodiment, the antenna feed elements of each feed network are arranged in rows. The antenna feed elements of network 1 and the antenna feed elements of feed network 3 (“odd feed networks”) are arranged in four rows, where the antenna feed elements of network 1 alternate with the antenna feed elements of network 3 along the four rows. Similarly, the antenna feed elements of feed network 2 and feed network 4 (“even feed networks”) are arranged in three rows, where the antenna feed elements of network 2 alternate with the antenna feed elements of network 4 along the three rows. The rows of antenna feed elements comprising the even feed networks are positioned in parallel between the rows of antenna feed elements comprising the odd feed networks in an offset arrangement where the antenna feed elements of the odd feed networks are aligned in columns and the antenna feed elements of the even feed networks are aligned in different columns than the antenna feed elements of the odd feed networks. Each row and column of antenna elements can follow the curvature of the electromagnetic lens 105 to allow each antenna feed element disposed along the rows and columns to radiate electromagnetic energy through a focal point of the electromagnetic lens 105.

The multi-beam antenna system 200 can further comprise network transmission modules 270 for sending signals to antenna feed elements and network receiving modules 280 for receiving signals from antenna feed elements. In this embodiment, each feed network comprises one network transmission module 270 and one network receiving module 280.

The multi-beam antenna system 200 can further comprise one or more transmission lines 285 connected to each antenna feed element via a feed port associated with the antenna feed elements. The transmission lines 285 can feed a signal from a network transmission module 270 to an antenna feed element. Similarly, the transmission lines can feed a signal from an antenna feed element to a network receiving module 280. In this embodiment, the multi-beam antenna system 200 comprises a network of transmission lines for each row of antenna feed elements of each feed network. For example, feed network 1 comprises four networks of transmission lines, one for each of the four rows of antenna feed elements. In other embodiments, a single network of transmission lines can be used to connect each antenna feed element of a feed network to a network transmission module 270 and/or a network receiving module 280.

The multi-beam antenna system 200 can further comprise a switching network 275. The switching network 275 can comprise a switch, such as a circulator switch, for each antenna feed element of the feed array 260. Each switch of the switching network 275 can allow or block a signal transmission along the transmission line between an antenna feed element and a network transmission module 270 or network receiving module. In this embodiment, the switches of the switching network can be controlled by beam control electronics 205.

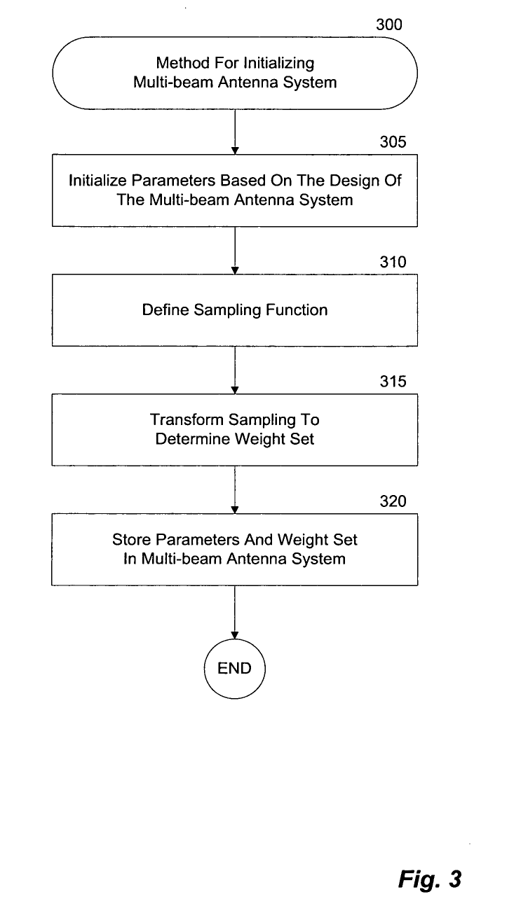

The beam control electronics 205 can receive a direction for transmitting or receiving an electromagnetic signal. The beam control electronics 205 can comprise a microprocessor, digital controller, or other circuitry for selecting antenna feed elements of the feed array 260 to transmit or receive the electromagnetic signal based on the received direction. The beam control electronics 205 can also compute or otherwise determine a feed weight comprising an amplitude or intensity and a phase shift for the electromagnetic signal at each selected antenna feed element. The feed weight can be determined based on a weight set stored on the multi-beam antenna system 200. This weight set will be described below with reference to FIG. 3.

Prior to the multi-beam antenna system 200 transmitting or receiving an electromagnetic signal, the beam control electronics 205 can actuate switches in the switching network 275 corresponding to each of the selected antenna feed elements and communicate the feed weights for each selected antenna feed element to a variable power divider (“VPD”) 220 (transmitting) or to a variable power combiner (“VPC”) 240 (receiving). A typical embodiment of a VPD includes two power splitters and two phase shifters. Similarly, a typical embodiment of a VPC includes two power combiners and two phase shifters.

In this embodiment, the VPD 220 comprises three VPD splitters 221, 222, and 223. VPD splitter 221 can receive a signal for transmitting in the received direction and can divide the signal between the odd and even feed networks based on the feed weights. The phase shifter can then apply a phase shift to each of the split signals based on the feed weights. VPD splitter 222 can receive the split signal for the odd feed networks and further split the signal between network 1 and network 3 based on the feed weights. Similarly, VPD splitter 223 can receive the signal for the even feed networks and further split the signal between network 2 and network 4 based on the feed weights. The VPD splitters 222 and 223 can then communicate the split signals to a network transmission module 270 for their respective networks. The network transmission modules 270 can communicate the split signals through the actuated switches 275 to the selected antenna feed element.

Similarly, when the multi-beam antenna system 200 is receiving an electromagnetic signal, each selected antenna feed element can communicate the received signal to a network receiving module 280 for the network associated with the antenna feed element. The network receiving module 280 can then send the signal to a VPC. In this embodiment, the VPC 240 comprises three VPC combiners 241, 242, 243, and a phase shifter. VPC combiner 242 can combine the signals received from feed networks 1 and 3 based on the feed weights. Similarly, VPC combiner 243 can combine phase shifted signals from feed networks 2 and 4 based on the feed weights. VPC combiners 242 and 243 can each communicate the combined signals to the phase shifter and the phase shifter can apply a phase sift to each of the combined signals based on the feed weights. The phase shifter can then communicate the phase shifted signals VPC combiner 241. VPC combiner 241 can then use the feed weights to produce a final signal representative of the electromagnetic signal received at the multi-beam antenna system 200.

The multi-beam antenna system 200 can include separate antenna feed networks for transmitting and receiving signals at different frequencies or polarizations. In this embodiment, each frequency or polarization comprises a separate network of feeds, switches, VPDs, and beam control electronics. These separate antenna feed networks can be interleaved to share a common lens or other aperture and the space available around the aperture. Although the multi-beam antenna system 200 shows both a transmit and receive network, the invention is equally valid for transmit only and receive only applications.

Turning now to FIG. 3, the figure illustrates a flow diagram 300 of a process for initializing a multi-beam antenna system according to certain exemplary embodiments of the present invention. Certain steps in the processes or process flows disclosed herein may need to naturally precede others to achieve desired functionality. However, the invention is not limited to the order of the steps described if such order or sequence does not adversely alter the functionality of the invention to the point of inoperability. That is, it is recognized that some steps may be performed before, after, or in parallel with other steps without departing from the scope or spirit of the invention. The flow diagram 300 will be discussed largely with reference to FIGS. 2 and 3.

At step 305, parameters of a multi-beam antenna system 300 are initialized based on the design of the multi-beam antenna system 200. These parameters can include a measure of spacing between feed elements, a size of an electromagnetic lens, and a frequency of operation for the multi-beam antenna system 200. In some embodiments, other parameters may be initialized such as lens type, antenna feed element design, and multiple frequencies of operation. These parameters can typically be set once after the multi-beam antenna system 200 is manufactured, but can be updated to reflect a change in design or frequency of operation. In one embodiment, the parameters can be initialized via a software user interface executing on a computer coupled to the multi-beam antenna system 200.

At step 310, a sampling function is defined for the multi-beam antenna system 200 based on the parameters initialized in step 305. An exemplary sampling function can be defined for a spherical coordinate system using the following equation:

$$W ( θ , φ , χ ) = {\sum }_{μ = - n}^{n} {d}_{μ m}^{n} ( θ ) {e}^{i m φ} {e}^{i μ χ} .$$

Here W(θ,φ,χ) is the function that describes a transformation from one spherical coordinate system to another. Here, the transformation is a rotation by the Euler angle set (θ,φ,χ). For this function, the feed spacing would be at a Nyquist rate given by 360°/ka where

$$ka = \frac{2 π}{λ} a ,$$

λ is the wavelength corresponding to the operating frequency, and a is the radius of a minimum sphere that encloses the antenna. At the Nyquist rate, the number of antenna feed elements, N, is given by N=ka. For wider feed spacings, N<ka. This results in sampling at rates lower than the Nyquist rate and aliasing occurs. For these cases, the sampling function would be chosen so that it aliases to W(θ,φ,χ). Aliasing is also beneficial in that it leads to fewer antenna feed elements. Wider antenna feed element spacings create additional room for interleaving multiple frequencies and polarizations while sharing the same aperture.

For other geometries such as planar and cylindrical, there is a corresponding coordinate transformation function similar to W(θ,φ,χ) and a defined Nyquist rate that serves as a sampling figure of merit. For wider feed spacings, the transformation function is chosen to alias to the Nyquist sampled version.

At step 315, the sampling function is transformed to determine a weight set for the multi-beam antenna system 200. This transformation is a conversion from beam pattern space to aperture illumination space. For the function W(θ,φ,χ) described above, this transform is accomplished using discrete Fourier series. For other coordinate systems, a similar series approach is used.

At step 320, the parameters and weight set can be stored in a memory location on the multi-beam antenna system 200.

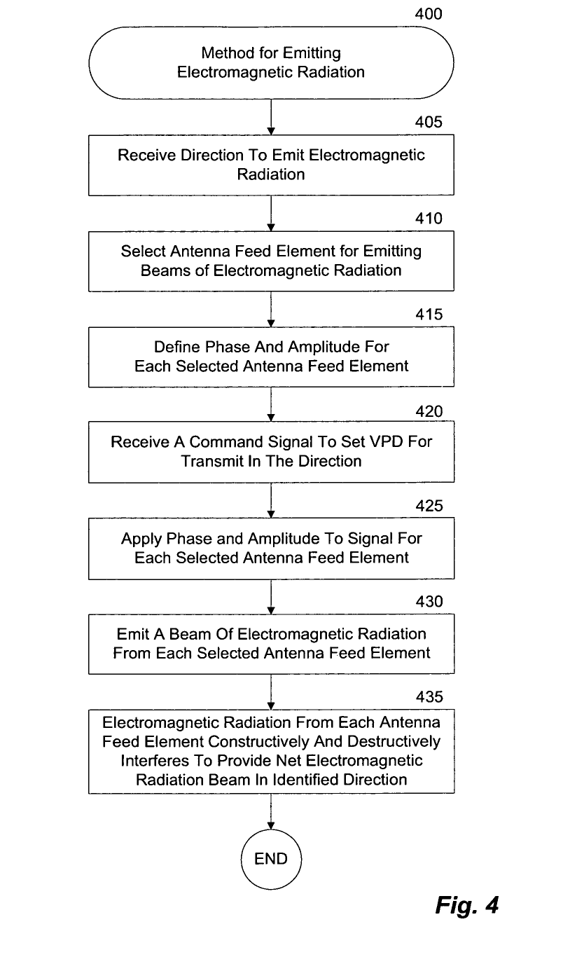

Turning now to FIG. 4, the figure illustrates a flow diagram 400 of a process for emitting a beam of electromagnetic radiation from a multi-beam antenna system according to certain exemplary embodiments of the present invention. The flow diagram 400 will be discussed largely with reference to FIGS. 2 and 4.

At step 405, a direction for radiating a beam of electromagnetic energy is received by the beam control electronics 205. This direction can be received from various devices depending on the application of the multi-beam antenna system 200. For example, if the multi-beam antenna system 200 is installed in a fixed location and communicates with one or more antennas on platforms such as satellites, aircraft, ships or ground based locations that are fixed with respect to the multi-beam antenna system 200, directional information can be downloaded to the multi-beam antenna system 200 from a computer or other programmable device and stored in a memory location on the multi-beam antenna system 200. Or, if the location of the multi-beam antenna system 200 is dynamic with respect to the one or more antennas and/or satellites, then an electronic receiver can receive updated directional information and communicate this directional information to the beam control electronics 205.

At step 410, the beam control electronics 205 selects antenna feed elements of the feed array 260 to radiate beams of electromagnetic energy based on the direction received in step 405.

In this embodiment, up to four antenna feed elements (one from each network) can be selected to each radiate a beam of electromagnetic energy depending on this direction.

At step 415, the beam control electronics 105 defines a feed weight for each selected antenna feed element based on the direction received in step 405. As discussed above with reference to FIG. 2, each feed weight comprises an amplitude and a phase shift corresponding to the beam of electromagnetic signal that the antenna feed element is to radiate. The feed weights can be defined based on the weight set determined in step 315 of FIG. 3. After defining the feed weights for each selected antenna feed element, the beam control electronics 105 can communicate the feed weights to the VPD 220.

At step 420, the VPD 220 receives a command signal to set the VPD for transmit in the received direction. The signal can be received via an interface coupled to the multi-beam antenna system 200.

At step 425, the VPD 220 splits the signal, and therefore adjusts the amplitude of the signal, based on the feed weights using a two step process as described above with reference to FIG. 2. The phase shifter of the VPD 220 also applies a phase shift to the split signals based on the feed weights. After adjusting the phase and amplitude of the signal for each network, the VPD 220 communicates the amplitude and phase adjusted signals to the network transmission modules 270. Each network transmission module 270 can then communicate the phase shifted signal along the transmission lines 285.

At step 430, the beam control electronics 205 actuates a switch in each feed network corresponding to the selected antenna feed element for each feed network. The selected antenna feed elements then receive the signal from their respective network transmission module 270 and radiates a beam of electromagnetic energy corresponding to the signal into the electromagnetic lens. Each beam of electromagnetic energy propagates on a delivery axis defined by the position and direction of the antenna feed elements from which the beam originated.

At step 435, the electromagnetic radiation from each antenna feed element constructively and destructively interferes where appropriate to provide a net beam of electromagnetic radiation propagating in the direction received in step 405.

Although the process 400 is described above in connection with the radiation or transmission of an electromagnetic signal, the process 400 may also function in reverse due to electromagnetic reciprocity. Such reverse operation of process 400 may be considered signal reception where the multi-beam antenna system 200 operates as a receiving antenna that is excited by the surrounding medium instead of exciting the surrounding medium.

From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the exemplary embodiments, equivalents of the elements shown therein will suggest themselves to those skilled in the art, and ways of constructing other embodiments of the present invention will suggest themselves to practitioners of the art. Therefore, the scope of the present invention is to be limited only by the claims that follow.

What is claimed is:

1. A method for emitting electromagnetic radiation, comprising the steps of:
emitting a first beam of electromagnetic radiation from a first antenna feed element aimed in a first direction;
emitting a second beam of electromagnetic radiation from a second antenna feed element aimed in a second direction; and
providing a third beam of electromagnetic radiation propagating in a third direction different than the first direction and the second direction, in response to adjusting a respective phase and a respective amplitude of each of the first and second beams of electromagnetic radiations to provide constructive interference and destructive interference of the first beam of electromagnetic radiation and the second beam of electromagnetic radiation.

2. The method of claim 1, wherein the first antenna feed element and the second antenna feed element are disposed in fixed positions with respect one another.

3. The method of claim 1, wherein at least a substantial portion of the constructive interference and destructive interference occurs in a lens.

4. The method of claim 3, wherein the lens comprises a spherical shape.

5. The method of claim 3, wherein the lens comprises one of a constant-k lens, a gradient lens, a Rotman lens and a Luneburg lens.

6. The method of claim 3, wherein the lens comprises a non-spherical shape

7. The method of claim 3, wherein the lens is in optical communication with a reflector or other lenses.

8. The method of claim 1, wherein the first antenna feed element comprises a first waveguide disposed adjacent a lens and wherein the second antenna feed element comprises a second waveguide disposed adjacent the lens.

9. The method of claim 1, wherein a variable power divider adjusts the respective amplitudes of each of the first and second beams of electromagnetic radiations.

10. The method of claim 1, wherein the respective phase and amplitudes are chosen to allow a distance of separation between the first antenna feed element and the second antenna feed element, the distance of separation comprising a distance greater than that predicted by Nyquist sampling.

11. An antenna system comprising:
a first antenna feed element disposed adjacent to a lens and operable to radiate a first beam of electromagnetic energy in a first direction through the lens;
a second antenna feed element disposed adjacent to the lens and operable to radiate a second beam of electromagnetic energy in a second direction through the lens; and
a control circuit, operably coupled to the first antenna feed element and the second antenna feed element, that is operable to create and steer a third beam of electromagnetic energy in a third direction between the first direction and the second direction via manipulating phase and intensity of each of the first beam and the second beam.

12. The antenna system of claim 11, wherein the lens comprises a spherical lens.

13. The antenna system of claim 11, wherein the lens comprises one of a constant-k lens, a gradient lens, and a Luneburg lens.

14. The antenna system of claim 11, wherein the lens comprises a non-spherical shape.

15. The antenna system of claim 11, further comprising a reflector or additional lens in optical communication with the lens.

16. The antenna system of claim 11, wherein each of the first antenna feed element and the second antenna feed element comprises one of a waveguide, a horn and a low gain radiating antenna.

17. The antenna system of claim 11, wherein the control circuit comprises a variable power divider for adjusting the intensity of each of the first beam and the second beam.

18. The antenna system of claim 17, wherein the control circuit comprises a microprocessor for computing a phase and intensity for each of the first beam and the second beam.

19. The antenna system of claim 11, further comprising an array of antenna feed elements, including the first antenna feed element and the second antenna feed element.

20. The antenna system of claim 19, wherein the array of antenna feed elements comprises a plurality of antenna feed networks, each antenna feed network comprising a plurality of antenna feed elements disposed adjacent to the lens for emitting electromagnetic radiation through the lens at a different frequency than the plurality of antenna feed elements of each other antenna feed network.

21. The antenna system of claim 19, wherein the array of antenna feed elements comprises a plurality of antenna feed networks, each antenna feed network comprising a plurality of antenna feed elements disposed adjacent to the lens for emitting electromagnetic radiation through the lens at a different polarization than the plurality of antenna feed elements of each other antenna feed network.

22. The antenna system of claim 19, wherein the respective phase and amplitudes are chosen to allow a distance of separation between each of the antenna feed elements in the array of antenna feed elements, the distance of separation comprising a distance greater than that predicted by Nyquist sampling.

23. A method for emitting electromagnetic radiation, comprising the steps of:
receiving a signal conveying a direction;
based on the direction, selecting a plurality of antenna feed elements, from an array of antenna feed elements, that are each pointed towards a lens and in a different direction;
computing a respective phase and respective intensity for each of the plurality of antenna feed elements based on the direction; and
emitting electromagnetic radiation from each of the plurality of antenna feed elements according to the computed phases and intensities.

24. The method of claim 23, wherein a microprocessor computes the respective phase and respective intensities for each of the plurality of antenna feed elements.

25. The method of claim 23, wherein the array of antenna feed elements comprises a first antenna feed network and a second antenna feed network, the first antenna feed network comprising a first portion of the plurality of antenna feed elements for emitting electromagnetic radiation at a first frequency, and the second antenna feed network comprising a second portion of the plurality of antenna feed elements for emitting electromagnetic radiation at a second frequency.

26. The method of claim 23, wherein the array of antenna feed elements comprises a first antenna feed network and a second antenna feed network, the first antenna feed network comprising a first portion of the plurality of antenna feed elements for emitting electromagnetic radiation at a first polarization, and the second antenna feed network comprising a second portion of the plurality of antenna feed elements for emitting electromagnetic radiation at a second polarization.

27. The method of claim 23, wherein the lens comprises a spherical shape.

28. The method of claim 23, wherein the lens comprises one of a constant-k lens, a gradient lens, and a Luneburg lens.

29. The method of claim 23, wherein each of the plurality of antenna feed elements comprises a waveguide or low directivity antenna.

30. The method of claim 23, wherein the respective phase and intensities are chosen to allow a distance of separation between each of the antenna feed elements in the array of antenna feed elements, the distance of separation comprising a distance greater than that predicted by Nyquist sampling.
